(19) United States
(12) Patent Application Publication
(10) Pub. No.: US 2024/0386733 A1
(43) Pub. Date: Nov. 21, 2024

(54) SCENE UNDERSTANDING USING LANGUAGE MODELS FOR ROBOTICS SYSTEMS AND APPLICATIONS

(71) Applicant: NVIDIA Corporation, Santa Clara, CA (US)

(72) Inventors: Animesh GARG, Redmond, WA (US); Dieter FOX, Seattle, WA (US); Tucker Ryer HERMANS, Salt Lake City, UT (US); Weiyu LIU, Atlanta, GA (US)

(73) Assignee: NVIDIA Corporation, Santa Clara, CA (US)

(21) Appl. No.: 18/319,546

(22) Filed: May 18, 2023

(51) Int. Cl. G06V 20/70; G06V 10/26; G06V 10/774; G06V 20/64

(52) U.S. Cl. CPC G06V 20/70; G06V 10/267; G06V 10/774; G06V 20/64; G06V 10/82

(57) ABSTRACT

In various examples, 3D object knowledge can be developed to extract diverse knowledge from large language models, and a part-grounding model can be trained to ground part semantics in terms of local shape features and spatial relations between parts. For example, knowledge that “the opening part of a mug that affords the pouring action is located on the top of the mug body and is often circular” can be grounded by identifying a previously unknown “opening” part based on its spatial relation to the known “body” part and its circular shape. A robotic system, for example, may use a model to identify an unlabeled part of a 3D object in imaging data. The model may be generated using natural language descriptions of relationships between parts of 3D objects, with descriptions generated using a language model that produces text in response to queries related to spatial relationships between the parts.

### BACKGROUND

Large-scale knowledge bases for robotic systems provide knowledge about objects. However, there may be knowledge missing in these knowledge bases, and so understanding a robotic system's surroundings may require making inferences based on known facts. Some methods, however, only perform reasoning at the textual level (e.g., relying on detection methods with predefined word labels), do not localize parts, and/or are not able to perform segmentation of objects into constituent parts-especially for objects that lack a uniquely distinct shape. Some methods involve learning visual representations for specific tasks, but these methods lack the necessary abstraction to transfer between tasks. In general, prior approaches model spatial relations and object properties of whole objects, and lack the ability to generalize to novel object categories and tasks.

### SUMMARY

Embodiments of the present disclosure relate to grounding knowledge of objects in three dimensions for generalizable manipulation. Systems and methods are disclosed that can generate or deploy machine learning models to identify unlabeled regions of three-dimensional (3D) objects in imaging data, allowing for more effective interaction with the 3D objects.

In contrast to conventional systems, embodiments of the disclosed approach can develop 3D object knowledge to extract diverse knowledge from language models—such as large language models (LLMs)—and can learn a part-grounding model to ground part semantics in terms of local shape features and spatial relations between parts. For example, the knowledge that “the opening part of a mug that affords the pouring action is located on the top of the mug body and is often circular” can be grounded by identifying a previously unknown “opening” part based on its spatial relation to the known “body” part and its circular shape.

At least one aspect relates to a processor. In various embodiments, the processor can comprise, or can be, one or more circuits. The one or more circuits may segment, based at least on a query, a 3D object in imaging data, the 3D object comprising an unlabeled region. The segmenting may comprise providing, to a model, imaging data comprising the 3D object, and receiving, from the model, an identification of the unlabeled region of the 3D object in the imaging data.

In various embodiments, the identification comprises, or is, a segmentation mask. In various embodiments, the identification comprises, or is, a pointwise label. In various embodiments, the identification comprises, or is, a set of pixels. In various embodiments, the query comprises, or is, a task to be performed. In various embodiments, the query corresponds to, or is, an interaction with the 3D object. In various embodiments, the query corresponds to, or is, an interaction between the 3D object and a second 3D object. In various embodiments, the query is provided to the model to obtain the identification of the unlabeled region. In various embodiments, the model is updated using training data comprising natural language descriptions of relationships between a plurality of parts of the 3D object. In various embodiments, the plurality of parts of the 3D object are obtained using a dataset of 3D objects annotated with hierarchical 3D part information. In various embodiments, the natural language descriptions of the relationships are generated at least in part using a language model that produces human-like text. In various embodiments, the language model comprises a generative transformer network that provides the natural language descriptions in response to queries that are related to spatial relationships between the plurality of parts of the 3D object. In various embodiments, the one or more circuits are to generate an instruction to cause an interaction with the 3D object based at least on the identification of the unlabeled portion. In various embodiments, the one or more circuits are to receive, prior to segmenting the 3D object in the imaging data, an action to be performed with respect to the 3D object, and generate the query based at least on the action.

Another aspect relates to a processor. The processor can be, or can comprise, one or more circuits. The one or more circuits may generate, for a 3D object, training data comprising natural language descriptions of relationships between a plurality of parts of the 3D object, the natural language descriptions generated at least in part using a language model that produces human-like text in response to queries, the natural language descriptions generated by providing the language model queries related to spatial relationships between the plurality of parts of the 3D object. The one or more circuits may update, using the training data, a model to segment the 3D object in imaging data by receiving the imaging data and providing an identification of an unlabeled region of the 3D object in the imaging data.

In various embodiments, the language model comprises a generative transformer network. In various embodiments, the one or more circuits are to obtain the plurality of parts of the 3D object from a dataset of 3D objects annotated with hierarchical 3D part information. In various embodiments, the one or more circuits are to use the model to identify, in second imaging data, an unlabeled region of (i) the 3D object or (ii) a second 3D object. In various embodiments, the model is trained to segment, in second imaging data, the 3D object or a second 3D object. In various embodiments, the 3D object or the second 3D object is segmented based on a query corresponding to an interaction between at least two of: (i) the 3D object, (ii) the second 3D object, or (iii) a third 3D object. In various embodiments, the one or more circuits are to use the model by providing, to the model, second imaging data comprising a second 3D object, and receiving, from the model, at least one of a segmentation mask, a pointwise label, or a set of pixels corresponding to an unlabeled region of the second 3D object.

In various embodiments, the processors, systems, and/or methods described herein can be implemented by or via, or can be included in, at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for three-dimensional (3D) assets; a system for performing deep learning operations; a system implemented using an edge device; a system implemented using a robot; a system for performing conversational AI operations; a system implementing one or more large language models (LLMs)—which may process text, audio, sensor (e.g., image, LiDAR, etc.) data to generate one or more outputs, a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for grounding knowledge of objects in three dimensions for generalizable manipulation are described in detail below with reference to the attached drawing figures, wherein:

FIG. 1 is a flow diagram of an example process of updating and using a model, in accordance with at least some embodiments of the present disclosure;

FIG. 2 provides an example set of 3D objects with different potential configurations (e.g., different cup shapes) and identification of parts thereof for use in implementing at least some embodiments of the present disclosure;

FIG. 3 provides example tasks that may be performed by an example robotic system with respect to one or more 3D objects in the robotic system's environment, in accordance with at least some embodiments of the present disclosure;

FIG. 4 is a flow diagram of example steps for collecting spatial relations between object parts, in accordance with at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

Systems and methods are disclosed related to grounding knowledge of objects in three dimensions for generalizable manipulation.

Robotic systems, or other autonomous and/or semi-autonomous systems, can more effectively interact with their surroundings if they have a better understanding of objects in their environment. If a robotic system determines that a task is to be performed with respect to an object, or receives a command to perform the task from another system, the system might need to make inferences to perform the task. For example, if a robotic system decides that a cup is to be placed on a counter or in a dishwasher, or receives a command to place the cup on the counter or in the dishwasher, the system might use a vision system to look for and identify a cup, but if the system has not previously recognized a particular object (with its unique shape) in its surroundings as being a cup, the system might first need to make an inference that the particular object is a cup. Once the robotic system identifies the cup (or if it was previously identified as being a cup), the system may determine how to interact with the object. For example, the cup may need to be grasped, moved from its origin, and placed at its destination. However, and especially if the cup is currently not empty, the robotic system may not be able to simply grasp the cup at any part or in any orientation (without an unwanted consequence such as spilling the cup's contents). For example, depending on the center of gravity of the cup, the system might need to grasp the cup at a particular part of the cup. Even with an empty cup, the system might, for example, place the cup on the counter on its side rather than on its bottom, or place the cup in the dishwasher with the opening of the cup facing up rather than down. While placing the cup on the counter on its side, or placing the cup in the dishwasher with its opening up, might technically accomplish the task of moving the cup from one place to another, performing the tasks in this way might not be desirable for one or more reasons. For example, if the cup is placed on a counter on its side, the cup might roll off the counter, or if the cup is placed in a dishwasher with its opening up, the cup might not get cleaned by the water jets of the dishwasher, and may be left with sitting water at the end of the dishwasher cycle.

Some large-scale knowledge bases for robotic systems, such as “KnowRob” and “RoboBrain”, can provide rich knowledge about objects. Computational frameworks such as knowledge embeddings (which use representations of text in which the meanings of words are encoded such that words closer together in a vector space are expected to be more similar in meaning) and transformer networks (which use artificial neural networks to generalize knowledge from observations of objects) have been introduced to learn relations between object properties and infer missing knowledge based on known facts. Knowledge about object affordance (which can identify how an object is used) and geometries has been extracted from large language models (LLMs) (which involve natural language processing). LLMs have also facilitated task planning which requires understanding the states and functions of objects. These methods, however, only perform reasoning at the textual level or rely on detection methods with predefined word labels.

Representations of the different parts of objects have been introduced to 3D perception for retrieving object models given language descriptions, and conversely generating language descriptions of object models. However, these language reference tasks do not require localizing parts (e.g., subparts). Other methods examine discovering parts without regard for segmenting parts, such as the “PartNet” dataset that is often used to determine the names of the parts of objects. However, such segmenting of objects into constituent parts is limited when there are not distinct shape features that can be differentiated and segmented.

Other approaches seek to use structured sensorimotor representations for integrating perception with manipulation, which may combine semantic representations (the “what”) with the spatial indicators (the “where”) to aid manipulation of objects by robots. Vision-based object representations, such as affordance segmentation (which attempts to detect, simultaneously, multiple objects and their uses from images) and “keypoints” (which provide semantic representations of objects while ignoring details not relevant to a task), enable robots to generalize skills to newly-perceived objects based on what categories the objects belong to. Several task-oriented grasping methods have leveraged these visual representations to specify where to grasp an object and which part of the object to interact with the environment. However, a common issue of these methods is that the representations are learned for specific tasks without the necessary abstraction to easily transfer between tasks. Understanding spatio-semantic relations, such as “left” or “contain” (e.g., hold inside of) has also shown to be useful for many manipulation-based applications such as retrieval of objects and moving of objects. Perception that is “interactive” uses different sensor data (e.g., touch and sound) and exploratory actions (e.g., press and shake to better understand an object) to make sense of object properties such as “thin,” “rough,” and “compressible.” In general, however, such methods model spatial relations and object properties of whole objects rather than parts and subparts of objects, and lack the ability to generalize to novel object categories and tasks to other objects and tasks.

Embodiments of the disclosed approach may comprise developing 3D object knowledge by extracting diverse knowledge from LLMs and learning a part-grounding model to ground part semantics (e.g., the meaning and logic of the parts of objects) in terms of local shape features and spatial relations between parts of objects. For example, the knowledge that “the opening part of a mug that affords the pouring action is located on the top of the mug body and is often circular” can be grounded by identifying a previously unknown “opening” part based on its spatial relation to the known “body” part and its circular shape. Formally, the knowledge can be defined as “unary” facts specifying properties of local parts (e.g., (query part, circular)) and binary facts specifying spatial relations (e.g., (query part, on top of, anchor part)). Once there is an initial set of parts to anchor the system's understanding (which can be a small number of parts), new parts can be derived with spatial and geometric reasoning based on an understanding of the initial “anchor” parts.

Embodiments of the disclosed approach may involve building a knowledge base of objects with fine-grained correspondence between semantic properties and perceivable object features. Grounding of concepts on parts of 3D objects, and reasoning about spatial relations between these parts (e.g., identifying the opening part of a bottle located on the top part of the body), may be accomplished. 3D concepts can be used to define specific manipulation actions such as grasping a particular part of an object for a specific task (e.g., hand over a pair of scissors by grasping the blades) and placing an object in a specific pose or orientation (e.g., place the mug upside down in the dishwasher). 3D concepts can provide an abstraction for generalizing manipulation between object categories (e.g., a bowl should be placed in a dishwasher similarly to a mug with its opening facing down) and tasks (e.g., safely handing over a pair of scissors and using a pair of scissors rely on recognizing the same sharp part). Additional aspects, features, and advantages will be discussed below.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing light transport simulation, systems for performing collaborative content creation for 3D assets, systems implemented at least partially using cloud computing resources, and/or other types of systems.

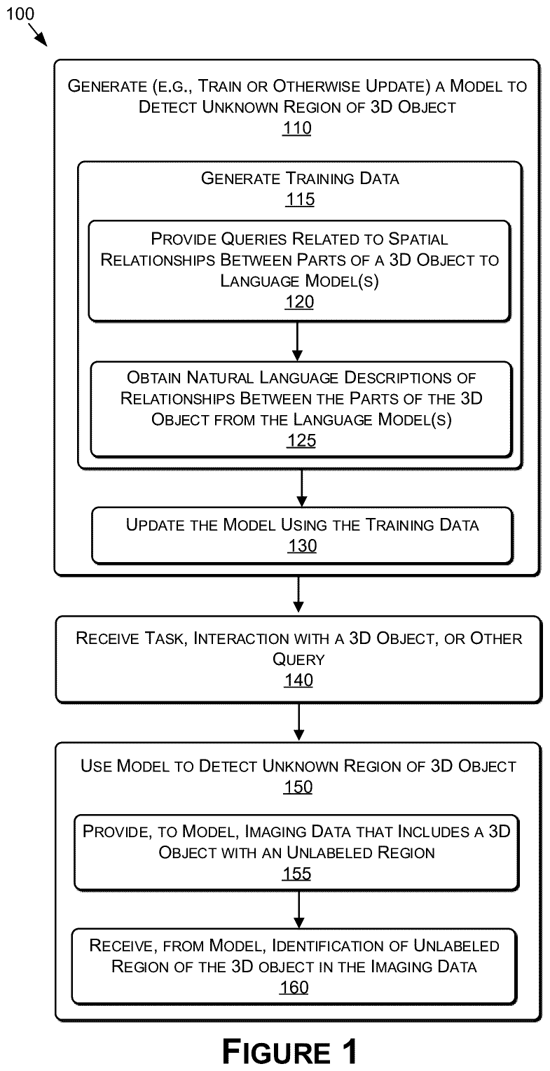

Turning to FIG. 1, depicted is an example process in accordance with some embodiments of the present disclosure. It should be understood that this and other arrangements described herein are set forth only as examples. Other arrangements, steps, and elements (e.g., machines, interfaces, functions, orders, groupings of functions, etc.) may be involved in addition to or instead of those shown, and certain elements or steps may be omitted altogether. Further, many of the elements employed to implement the disclosed approach described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each block of method 100 in FIG. 1, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 100 may be executed by any one system, or any combination of systems, including, but not limited to, those described herein.

FIG. 1 is a flow diagram showing a method 100 for generating one or more models to identify unknown (e.g., unlabeled) or insufficiently-understood regions of 3D objects, in accordance with some embodiments of the present disclosure. The method 100, at block 110, includes training or otherwise updating one or more models in generating a model that is capable of detecting an unrecognized region (e.g., part) of a 3D object in, for example, imaging data obtained by a vision system of a robotic or other autonomous or semi-autonomous system. The models may be, or may comprise, one or more neural networks. At block 140, method 100 includes receiving a query (e.g., a task to be performed, and/or an interaction by the robotic system with one or more objects in the system's environment or otherwise reachable by the robotic system). At block 150, method 100 includes using the generated model(s) to detect a previously unknown region of the 3D object in imaging data as part of, or in furtherance of, the performance of the task.

In accordance with some embodiments of the present disclosure, method 100, at block 115, includes generating training data for training, updating, or otherwise generating one or more models. At 120, as part of obtaining training data, a set of queries may be provided to one or more language models. The queries may be related to, for example, spatial relationships between parts of a 3D object. The language models may provide natural language descriptions of the 3D objects. The training data may comprise, or may be, the natural language descriptions from the language models. The names of the parts (between which spatial relationships are sought) may be obtained using one or more datasets of 3D objects. The datasets may include objects that are annotated with hierarchical 3D part information. As an example, such datasets may be, or may comprise, PartNet (https://partnet.cs.stanford.edu/). Table 1 provides example spatial relationships for parts of a bowl, bottle, and mug.

TABLE 1
Spatial relationships for mugs, bowls, and bottles

| | PARTS | SPATIAL RELATIONSHIPS |
|---|---|---|
| Bowl: | bowl/bottom, | 1. first part is at the top of the bottle, and |
| | bowl/container, | second part is at the bottom of the bottle. |
| | bowl/containing_{—} | 2. first part is on the side of the bottle, |
| | things | and second part is on the top of the bottle. |
| Bottle: | bottle/jug/body, | 3. first part is inside the mug, and second |
| | bottle/jug/handle, | part is attached to the mug. |
| | bottle/jug/mouth, | 4. first part is below second part. |
| | bottle/normal_{—} | 5. first part is narrower than second part. |
| | bottle/body, | 6. first part is at the top of the second part, |
| | bottle/normal_{—} | and the second part is below the first part. |
| | bottle/closure, | 7. first part is the surface on which second |
| | bottle/normal_{—} | part rests. |
| | bottle/handle, | 8. the first part of the jug is at the top, |
| | bottle/normal_{—} | and the second part is on the side. |
| | bottle/lid, | 9. first part is on the side of the second |
| | bottle/normal_{—} | part, and the second part is on the top of |
| | bottle/mouth, | the first part. |
| | bottle/normal_{—} | 10. first part is on the bottom, and second |
| | bottle/neck | part is on the top. |
| Mug: | mug/body, | 11. first part is on top of second part. |
| | mug/containing_{—} | 12. first part is on the top of second part. |
| | things, | 13. first part is surrounding second part. |
| | mug/handle | 14. first part is on the side of the mug, and |
| | | second part is inside the mug. |
| | | 15. first part is on the side of the jug, and |
| | | second part is on the top of the jug. |
| | | 16. first part is attached to second part. |
| | | 17. first part is inside second part. |
| | | 18. first part is at the top, and second |
| | | part is at the bottom. |
| | | 19. first part is sitting on second part. |
| | | 20. first part is on the top of the bottle, |
| | | and second part is on the bottom. |
| | | 21. first part is at the top of the bottle, |
| | | and second part is on the side of the bottle. |
| | | 22. first part is in second part. |
| | | 23. first part is at the top of second part. |

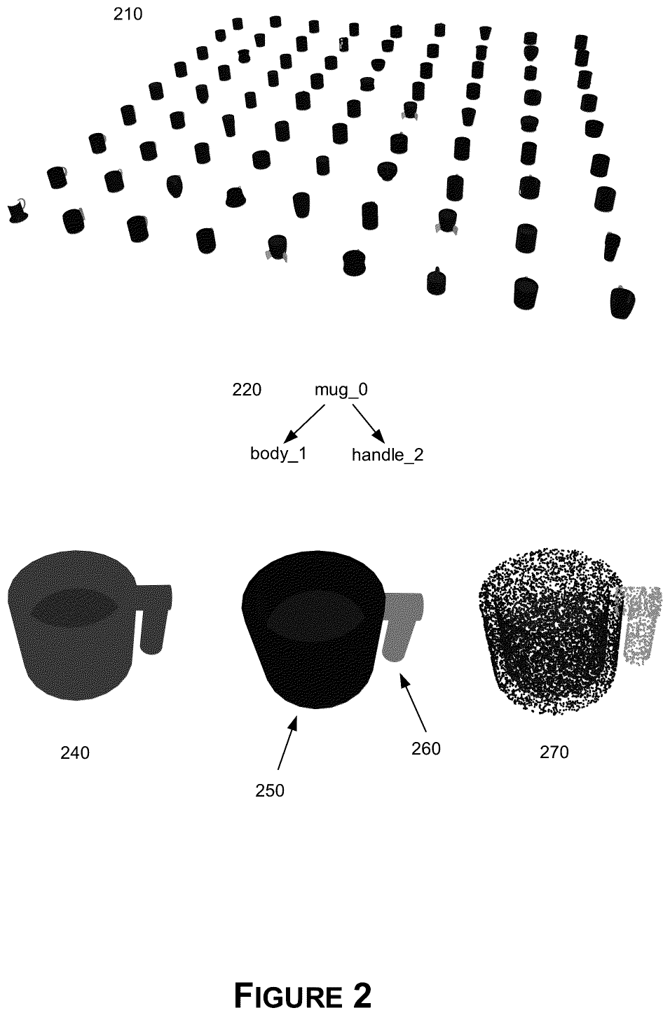

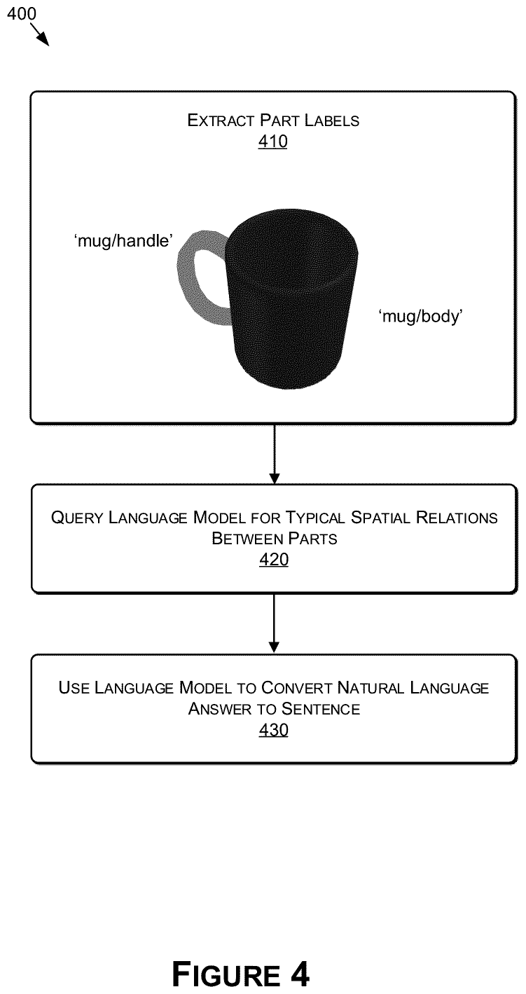

With reference also to FIG. 2, in some embodiments, hierarchy of the parts of 3D objects (210) may be built from, or otherwise based on, PartNet annotations, and incomplete PartNet object models may be aligned with, for example, the ShapeNet V2 model. Annotations may indicate, for example (at 220), that a mug 240 (“mug_0”) can be segmented into a body 250 (“body_1”) and a handle 260 (“handle_2”). Segmented point clouds (270) may be obtained, where each point (e.g., voxel) may correspond to a node in the hierarchy 220, allowing for use of arbitrary levels in the hierarchy. At block 125 of FIG. 1, method 100 includes obtaining natural language descriptions of spatial relationships between parts of the 3D objects. These natural language descriptions can be obtained by querying a language model for spatial relations between parts, as further discussed below with respect to FIG. 4. The language model may comprise, or may be, for example, Generative Pre-trained Transformer 3 (GPT-3). At block 130 of method 100, the model may be trained, or otherwise updated, using the natural language descriptions obtained using one or more language models.

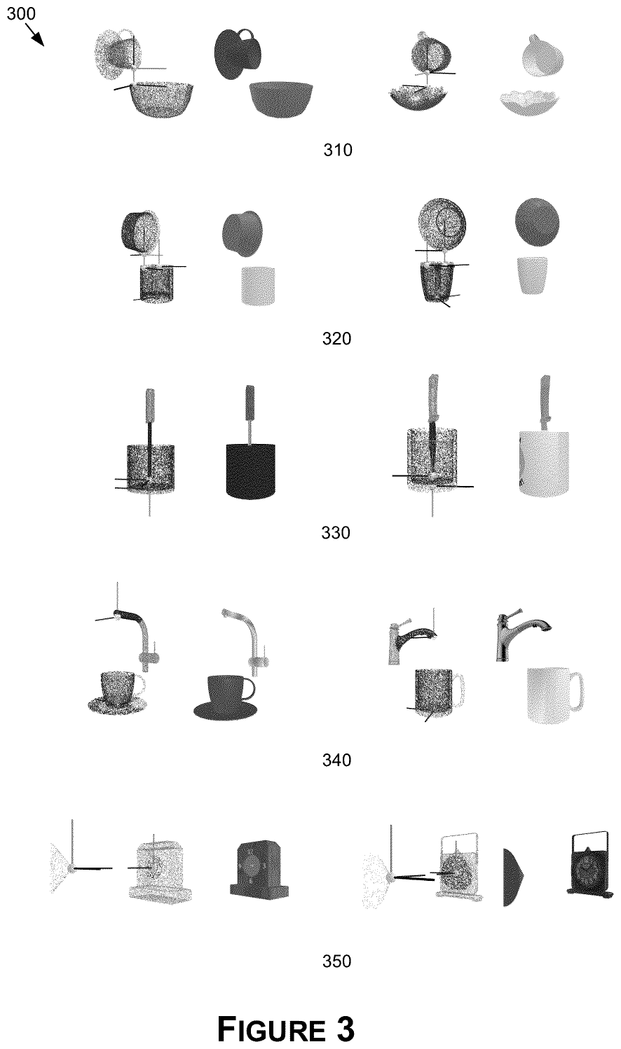

At block 140 of method 100, the system may receive a query. The query may be received from, for example, a user of the robotic system, or from a device or from another system providing instructions to the robotic system. The query may be a task. For example, the task may involve interaction (e.g., by the robotic system) with one object (e.g., take an object to a destination), or interaction (e.g., by the robotic system) with more than one object, such as interaction between two objects (e.g., pour water out of a container into a cup), or interaction among more than two objects (e.g., wash a dish at a faucet using a sponge). Example tasks can be found in FIG. 3, which provides, in particular, “pour from mug to bowl” at 310, “pour from bowl to mug” at 320, “put knife in mug” at 330, “place mug under faucet” at 340, and “place clock” at 350, as example tasks. In various embodiments, the task to be performed is not received from a user, device, or system, but rather is identified as a task to be performed based, for example, (i) on other information available to, or obtained by, the robotic system, (ii) on other programming of the robotic system, and/or (iii) on outputs of other models involved in determining the behavior or functionality of the robotic system.

At block 150, the robotic system may, based on a task, use the trained or otherwise updated model. The robotic system may comprise, or have access to, a vision system (e.g., one or more cameras, imaging optics, and/or other sensors) to obtain imaging data used to obtain information about the robotic system's surroundings. The imaging data may include an object with an unlabeled or otherwise unrecognized part. For example, the robotic system may recognize a cup in its field of view (FOV), but the robotic system may not have enough confidence that the task can be performed based only on the knowledge that the object within the FOV is a cup. The level of confidence can be determined based, for example, on past experiences of the robotic system and/or on how granular (e.g., fine-grained) the robotic system's knowledge of the 3D object is. The robotic system may, for example, not have performed the same task (or sufficiently similar task) with the same objects (or sufficiently similar objects) in the past.

At block 155, the robotic system may provide the imaging data obtained via the vision system to a trained or otherwise updated model. At block 160, the model may provide, in response to receiving the imaging data, an identification of a region of the 3D object in the imaging data as output to the robotic system. The region may have been previously unlabeled or otherwise not identified as a distinct part of the particular 3D object in the imaging data. The identification of the region may comprise, or may be, a segmentation mask, a pointwise label, and/or a set of pixels. The robotic system may have a better understanding of the object and/or the task because of the identification of the region from the model. The robotic system may take steps toward performing the task. The steps may include, for example, generating one or more commands or instructions to actuate one or more components of the robotic system to manipulate one or more objects in the robotic system's environment.

As suggested above, in accordance with various potential implementations, autonomous or semi-autonomous robotic systems that operate in diverse human environments need to interact with a wide range of objects while adapting to changes in task goals. Perceiving and understanding semantic properties of objects (e.g., a cup is ceramic, empty, located in kitchen, and used for drinking) has shown to enhance robot autonomy by inferring missing information in human instructions, efficiently searching for objects in homes, and manipulating objects based on their affordances and states. However, this textual representation of knowledge generalizes facts at the level of objects and lacks the granularity to localize object properties based on local geometry and functionalities (e.g., that the container part of a cup can be used to store liquid). The disclosed approach can provide a knowledge base of objects with more fine-grained (e.g., granular) correspondence between semantic properties and perceivable object features. Various embodiments provide grounding concepts on parts of 3D objects and reasoning about spatial relations between these parts (e.g., identifying the opening part of a bottle located on the top part of the body).

In various embodiments, concepts and spatial relations grounded on 3D objects can be used to define specific manipulation actions such as grasping a particular part of an object for a specific task and placing an object in a specific orientation. The symbolic representation of 3D objects also provides an abstraction for generalizing manipulation between object categories and tasks. Further, human users can leverage the vocabulary of 3D concepts to customize robot behavior and teach new knowledge about objects. Moreover, as robotic systems physically interact with objects in the environment, the symbolic knowledge can be further refined to reflect the capability of each robot and the constraint of each environment.

In various embodiments, 3D object knowledge can be defined as unary facts specifying properties of local parts (e.g., (query part, circular)) and binary facts specifying spatial relations (e.g., (query part, on top of, anchor part)). In some implementations, an assumption can be made that a small number of parts form the initial set of anchor parts. New parts can be derived, for example, via spatial and geometric reasoning. The disclosed approach can provide a part-level spatio-semantic representation for object manipulation. In various embodiments, a neural network model is used to localize object parts based on binary spatial relations and unary geometric attributes. In various embodiments, the model can comprise, or can be, one or more neural networks and/or other machine learning models. The disclosed framework can generalize part-aware pick-and-place actions and spatial interactions between objects to novel object categories and tasks.

In potential implementations, unary and binary facts grounded in 3D object models can be generated using a dataset (e.g., the PartNet dataset) and an LLM, as depicted in FIG. 4, and in particular, block 410 (e.g., a mug handle and a mug body). At block 420, given part segmentations from the dataset and their corresponding part labels (e.g., a bowl is segmented into the bottom of the bowl and a body of the bowl), unary facts can be extracted by querying the LLM for the geometric and/or functional properties of the parts (e.g., what is the shape of the bottom of a bowl?). At block 430, to extract binary facts, the LLM can be queried for the prototypical spatial relation between two parts (e.g., where is the bottom of a bowl with respect to the body?).

The grounded relational facts can be used to train a part-grounding model, which takes as input the 3D representation (e.g., point cloud) of an object, the anchor object part in the form of a segmentation mask, and a set of facts specifying the query object part. These facts contain information about the geometric features of the query part and its spatial relation to the anchor object part. The model can be trained to predict the segmentation mask of the query object part. During inference, the LLM and part-grounding model may be used together to provide semantic knowledge about object parts and localize object parts that can be used to parameterize manipulation actions. Because the LLM does not have access to the object models, a latent model can be used in some implementations to account for the variance between object instances and the mismatch between language description of object parts and observation of object parts.

### Example Computing Device

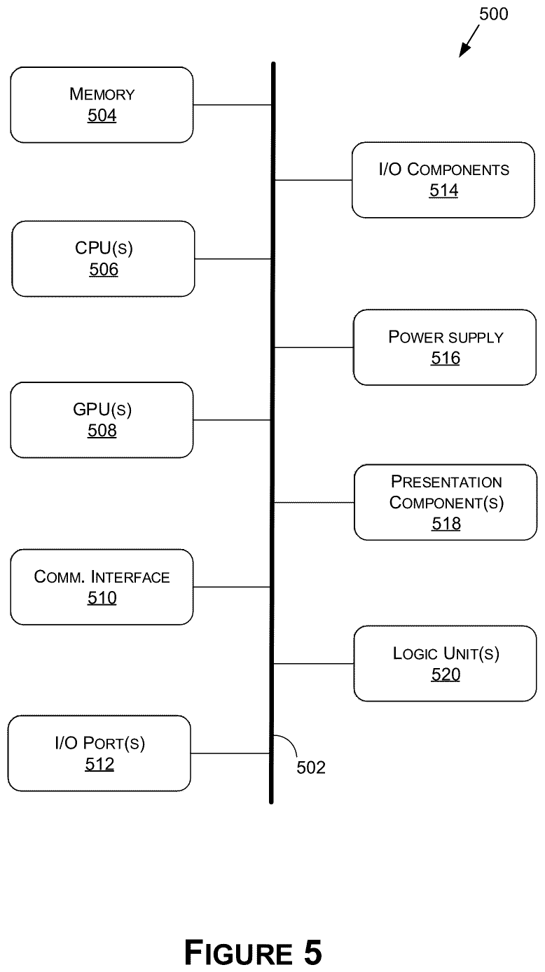

FIG. 5 is a block diagram of an example computing device(s) 500 suitable for use in implementing some embodiments of the present disclosure, such as generating models, providing commands (e.g., tasks) to a robotic system, etc. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

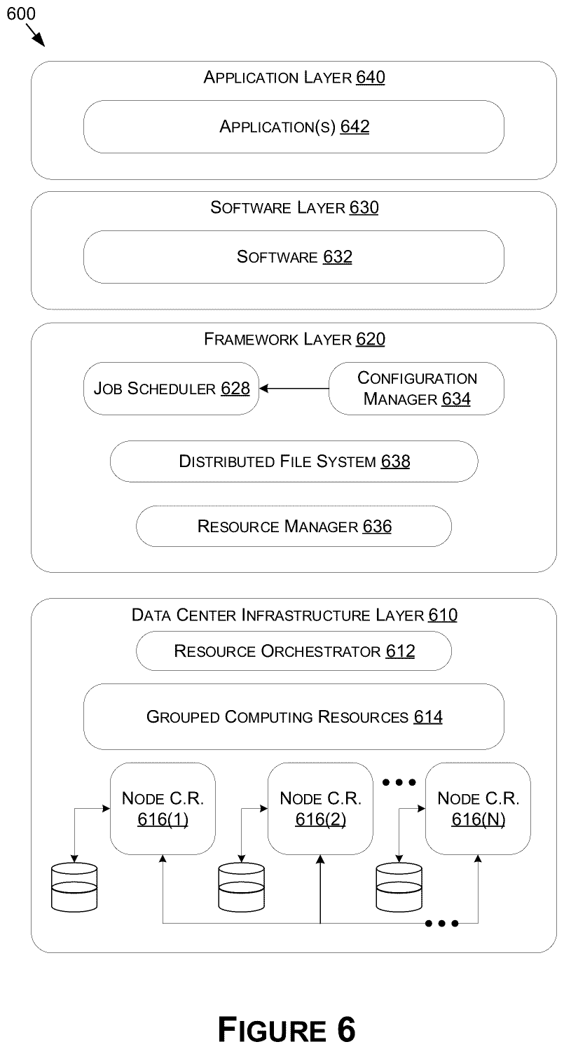

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
segment, based at least on a query, a three-dimensional (3D) object in imaging data, the 3D object comprising an unlabeled region, the segmenting comprising:
providing, to a model, the imaging data comprising the 3D object; and
receiving, from the model, an identification of the unlabeled region of the 3D object in the imaging data.

2. The processor of claim 1, wherein the identification comprises a segmentation mask.

3. The processor of claim 1, wherein the identification comprises a pointwise label or set of pixels.

4. The processor of claim 1, wherein the query corresponds to an interaction with the 3D object.

5. The processor of claim 1, wherein the query corresponds to an interaction between the 3D object and a second 3D object.

6. The processor of claim 1, wherein the query is provided to the model to obtain the identification of the unlabeled region.

7. The processor of claim 1, wherein the model is updated using training data comprising natural language descriptions of relationships between a plurality of parts of the 3D object.

8. The processor of claim 7, wherein the plurality of parts of the 3D object are obtained using a dataset of 3D objects annotated with hierarchical 3D part information.

9. The processor of claim 7, wherein the natural language descriptions of the relationships are generated at least in part using a language model that produces human-like text.

10. The processor of claim 9, wherein the language model comprises a generative transformer network that provides the natural language descriptions in response to queries that are related to spatial relationships between the plurality of parts of the 3D object.

11. The processor of claim 1, wherein the one or more circuits are to generate an instruction to cause an interaction with the 3D object based at least on the identification of the unlabeled portion.

12. The processor of claim 1, wherein the one or more circuits are to:
receive, prior to segmenting the 3D object in the imaging data, an action to be performed with respect to the 3D object; and
generate the query based at least on the action.

13. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

14. A processor comprising:
one or more circuits to:
generate, for a 3D object, training data comprising natural language descriptions of relationships between a plurality of parts of the 3D object, the natural language descriptions generated at least in part using a language model that produces text in response to queries, the natural language descriptions generated by providing the language model queries related to spatial relationships between the plurality of parts of the 3D object; and
update, using the training data, a model to segment the 3D object in imaging data by receiving the imaging data and providing an identification of an unlabeled region of the 3D object in the imaging data.

15. The processor of claim 14, wherein the language model comprises a generative transformer network.

16. The processor of claim 14, wherein the one or more circuits are to obtain the plurality of parts of the 3D object from a dataset of 3D objects annotated with hierarchical 3D part information.

17. The processor of claim 14, wherein the one or more circuits are to use the model to identify, in second imaging data, an unlabeled region of (i) the 3D object or (ii) a second 3D object.

18. The processor of claim 14, wherein the model is trained to segment, in second imaging data, the 3D object or a second 3D object.

19. The processor of claim 18, wherein the 3D object or the second 3D object is segmented based on a query corresponding to an interaction between at least two of: (i) the 3D object, (ii) the second 3D object, or (iii) a third 3D object.

20. The processor of claim 14, wherein the one or more circuits are to use the model by providing, to the model, second imaging data comprising a second 3D object, and receiving, from the model, at least one of a segmentation mask, a pointwise label, or a set of pixels corresponding to an unlabeled region of the second 3D object.
